(19) United States
(12) Patent Application Publication
(10) Pub. No.: US 2005/0107121 A1
(43) Pub. Date: May 19, 2005

(54) Method and system for enhance utilization of a cell phone

(76) Inventor: Oliver Wendel Gamble, New York, NY (US)

Correspondence Address: OLIVER W. GAMBLE, 436 EAST 75 STREET, NEW YORK, NY, 10021, US

(21) Appl. No.: 10/828,600

(22) Filed: Apr. 20, 2004

Related U.S. Application Data
(60) Provisional application No. 60/520,755, filed on Nov. 18, 2003.
(60) Provisional application No. 60/524,819, filed on Nov. 25, 2003.

(51) Int. Cl. H04B 1/38

(52) U.S. Cl. 455/557

(57) ABSTRACT

This invention will provide a means by which an extension phone can be attached to a wireless telephonic device. The addition of an extension to a cell phone will enable it to provide increase access and functionality. The extension phone capability will allow for greater access to the cell phone, ability to add on additional electronic devices, ability to personalize the behavior of the extension phone to mimic that of the cell phone (ringing signal), and the ability to hold multi-person conversations.

I claim the priority of provisional patent applications 60/520755 filed on Nov. 18, 2003, and 60/524819 filed on Nov. 25, 2003, these applications are incorporated by reference in their entirely.

### FIELD OF THE INVENTION

The invention relates to cell phone extensions that allow a user to operate a cell phone from more than one position within a location.

### BACKGROUND OF INVENTION

As consumers obtain both wired and wireless telephones an ever-increasing number of phone numbers to be memorized, communications becomes more bewildering, and expense increases. The ever-increasing number of cell phone users will necessitate a means of connecting landline and a wireless communication system. This connection need not be merger of the two systems (wire and wireless), but rather a method of using a cell phone as both a mobile and stationary communication devices.

U.S. Pat. No. 6,704,580 “Cellular telephone docking system”, issued Mar. 9, 2004, in the name of James Steven Fintel and assigned to Intel Corporation, shows a cell phone linking to a wired telephone in a manner that allows the user to receive calls via the cell phone on the wired telephone, and send calls from the wired telephone out over the cell phone line. There are several drawbacks to this system, first and foremost is the need for the user to have a “Local Telephone Network” for the wired telephone extensions connecting to the cell phones. Fintel's Patent also requires that all of the extensions phones be plugged into a wall socket, be connected to the “Local Telephone Network”. Fintel's Patent links each cell phone to a specific communication channel, to which one extension is connected. This necessitates the user being located at specific location to receive their incoming cellular calls. Fintel's Patent lacks a merging the functionality of a cell phone with that of a line phone, no method was given to determining when a complete phone number has be entered, no method for correcting a telephone number that was entered wrong (cell phones allow their users to remove enter digits of a telephone number one by one), and no method for initiating the dialing processing once a complete phone number is entered (cell phones require pressing a send key while a wired phone will have “Time-Out” event if all of a telephone number is not entered within a given period of time). Fintel's Patent will lack flexibility in number of users per units. Fintel's patent will come in a set number of docking bays per unit, there is not allowance for exact number of number of users. This will result in the docking unit being too small for some customers and too large for other customers.

Accordingly, it would be advantageous to have the ability to make and receive cellular calls from any available extension, to remove the need for a “Local Telephone Network”, the need to use wall jacks that connect to the “Local Telephone Network”, the need to be at a specific location to receive your incoming cell phone calls, to be able to add individual SkyRider units as needed. SkyRider can be used, in an office, at home, moving about, or in a third party's office. In addition the Base Unit (SkyRider) will charge the plugged in cell phone. Also include are buttons and features required to track and execute dialing procedure sent from an extension to a wireless device.

### SUMMARY OF INVENTION

The present invention relates generally to a method and system for linking line phone “EXTENSION” to a cellular phone. These “EXTENSIONS” will be referred to as E-Phones, E2Phone, or E3Phone. Typically a base unit of a wireless device is used for recharging the battery. In the preferred embodiment the Base Unit used in a SkyRider has one or more sockets into which “EXTENSION” phones, and wireless devices can be plugged. The “EXTENSION” phones that plugs into the base unit will be able to utilize a cell phone as a conduit to a communication network (i.e. Public Switch Telephone Network). An “EXTENSION” phone used with a SkyRider can appears to be a regular line phone found in either a home or office setting. The “EXTENSION” phone will allow the user to place and receive calls over an attached/linked cell phone. It should be note that a regular telephone can act as an “EXTENSION” Phone when attached to a base unit. The cell phone of a SkyRider can be linked to the base unit by either plugs into it, or by a connecting cable. In one embodiment the SkyRider (Base Unit) can be incorporated into an “EXTENSION” phone. In one embodiment a regular line phone can be used as an “Extension” phone, this type of extension is referred to as an E-Phone. In another embodiment an “EXTENSION” phone specially designed to work with a SkyRider is referred to as an E2Phone. In an alternate embodiment an “EXTENSION” phone designed to work with both a wired and wireless communication system is referred to as an E3Phone.

An E2Phone is basically an intercom with a keypad, a visual display system, memory, programming to control everything and a microprocessor to run the programming. In one embodiment users of a SkyRider with more than one E2Phone extension will be able to answer their cell phone from more than one location, be able to conduct group conversations with callers, and be able to view images (or text messages. The ability to more than one “EXTENSION” phones to a SkyRider making it possible for a single wireless device to provide service from several different locations within a single site (FIG. 3).

A SkyRider Base Unit will have telephone jacks, and the components needed for it to support the operation of the “EXTENSION” phone linked to it (FIG. 6), in addition to the components necessary for its normal recharging role. The Base Unit of a SkyRider can vary according to the type of “EXTENSION” phone plugged into it. In one embodiment an E-Phone interfacing with a SkyRider will behave as if it were a regular lined phone (Wired), and generate and response to all of the signals common to a line phone: Dial tones, Ringing, Incoming/Answering Call, and Outgoing Call (FIG. 4). The ability to generate and interact with Ringing, Dialing Outgoing Calls, and Answering Incoming Calls will allow the user to employ regular line phones as “EXTENSIONS”. In another embodiment a Base Unit will be digital, not have to generate ringing signal, or deal with line phone voltage attributes. This Base Unit will work with “EXTENSIONS” referred to as E2Phones. In the preferred embodiment E2Phones will be able to distribute many of the advance features of a cell phone to the E2Phone. The user will be able to have customize ringing, text messages, et cetera. In the preferred embodiment the “EXTENSIONS” will be able to display images on a screen that may be color, or a simple display (black and white/L.C.D). In the preferred embodiment the Base Unit will periodically check the charge status on the inserted cell phones, to determine if the charge should be employed. In one embodiment, a Base Unit detects the presence of a cell phone when the user places it into a slot and rotates it (90) ninety degrees. A light goes on and the battery status is checked.

SkyRider users will benefit from the comfort and ease of being able to use their cell phone in any room in a house/office, not having to use a small fragile dialing device, always knowing where there cell phone is located, having a fully charged cell phone waiting whenever they leave their house or office, and all of the advanced features that are being added to cell phones. In the preferred embodiment the multifunctional features of a cell phone can be distributed to the various “EXTENSION” phones (E-Phone, E2Phone, and E3Phone) located in the user house/office. In the preferred embodiment the charging system will allow the user to utilize the cell phone in a SkyRider (Base Unit) while it is charging. In another embodiment the SkyRider's ability to mimic a regular line signaling will enable its user to attach regular line phone external devices to it (i.e. Fax machines, or digital cameras). In an alternate embodiment the user can attached specially design external devices to the base unit (i.e. fax machine designed to work specifically with a cell phone).

### DETAILS DESCRIPTION

Basic of Wireless Telephones

A Cell phone requires three communication channels/frequencies to operate: one channel for incoming voice communication, one for outgoing voice communication, and one for control and regulations instructions for the cell phone. The separate channels for incoming and outgoing communication/conversation allows both the calling and answering parties to speak at the same time and be heard. This functionality is mimics from that of a regular line phone.

There is a variety of chips in a cell phone, the major chip components are the analog-to-digital and digital-to-analog conversion (A-D & D-A) chip, digital signal processing chip (DSP), memory chip, and the microprocessor chip. Each of these chips plays a significant role in the operation of a cell phone. Conversation/information is transmitted through the wireless communication network in a compress digitized format. The cell phone receives a compressed digitized package of information from a caller via the wireless network. The package contains both conversation and information about how to maintain the linkage with the caller. The information in the package was process (digitized and compressed) before it was transmitted to the receiving cell phone. The receiving cell phone will capture and de-process the transmitted package: decompress the digitized data, and then convert the digital information into analog (conversation) and control instructions. The digital processing is managed by a Digital Signal processing (DSP) chip, it is a highly customized processor designed to perform high speed signal-manipulation and calculations. DSP are rated upward of 40 MIPS (Millions of Instructions per Second) and handles all of the signal compression and decompression within the wireless device. The incoming communication is translated from its digital format to analog by an audio chip that converts “Digital to Analog and Analog to Digital”. The outgoing conversation/communication is picked up by the microphone and converted into an analog signal, that is digitized and compressed before being transmitted by the wireless device (cell phone) to the communication network.

The wireless device microprocessor handles all of the back-end operations of the cell phone: keyboard/keypad input, command request (Re-Dial, End call, look up phone number), display of information and pictures, commands and controls signaling (third channel) with the base station and everything else.

Memory in a cell phone comes in the form of ROM (Read Only Memory) and Flash memory chips. The wireless device memory is used for storage of the phone's operating system and customizable features: ringing, calendar, and directory.

The radio frequency (RF) and power section handle power management and recharging, and also deals with the hundreds of FM channels that are available to the phone for transmitting and receiving communication. Finally the RF amplifier handles signals traveling to and from the antenna.

The wireless device microprocessor handles all of the housekeeping chores from the keypad input monitoring, display output, command and control signaling with the base station. The cell phone's microprocessor coordinates the all of the activities/functions performed on its mother board, including input and output via the data bus connection between the cell to the Base Unit. The ROM and Flash memory chips provide storage for the phone's operating system and customizable features, such as the phone directory, ringing, et cetera. This memory can also be used to store coding that will control the linkage/interfacing between a Base Unit and the cell phone. Lastly, the RF amplifiers handle signals traveling to and from the antenna allowing communications via cell phone's “EXTENSIONS” (E-Phone, E2Phone, and E3Phone).

The Digital Signal Processing chip (DSP) in a wireless device is highly flexible in its programmability: it can be program to perform a wide variety of tasks. This programmable high-speed microprocessor can be programmed to monitor the signaling between a Base Unit and a cell phone, enabling the Base Unit Microprocessor to introduce information and commands into the wireless device. These commands and instructions can convey the outgoing telephone numbers to the wireless device's dialing buffer and effect said number being dialed. The combination of memory, program coding, and a programmable microprocessor to run the coding can be used to create a system that allow “EXTENSIONS” to be added to a cell phone. A Base Unit working with a wireless phone will function as an interface for the “EXTENSION” (E-Phones/E2Phone/E3Phone), enabling the “EXTENSIONS” to send and receive calls like a regular line phone via the wireless device.

Basics of Wired Telephones

Each subscriber to a wired telephone is connected to a central office that contains switching equipment, signaling equipment, and batteries that supply direct current to operate the telephone. The telephone is connected to the central office by what is termed a local loop, a pair of wires. One wire is called the “Tip” and the other wire is called the “Ring”: “T” and “R” respectively. A phone can be said to be in a neutral state when it is not in use, the handset is resting on the cradle (On Hook). When the handset is lifted from the cradle (Off Hook), a closed circuit is created between the central office and the phone, allowing current to flow between the Central Office and the phone over the loop. When a phone is on the hook (On Hook state), the central office will see it as an open circuit (incomplete local loop). The central office will monitor the state of the customer's line/local loop to detect Off Hook state (outgoing call). The local loop will appear as a completed local loop/closed circuit when the subscriber pick up the receiver (handset). The Ringer is the mean by which the subscriber is notified of an inbound call. The central office can send an electrical signal that will cause a phone to start ringing. The ringing signal (FIG. 4A) sent from the central office consist of a 70 to 90 volt AC signal at 17 Hertz to 20 Hertz transmitted over a local loop (subscriber phone line) from the central office. A Dial tone can vary from country to country, in America it is an unbroken distinct signal composed to two separate tones: 350 Hertz and 440 Hertz. Both the dial tone and the ringing signal are generated in the Central Office, not the telephone. The Ringer will ring when ever it encounters an incoming ringing signal, and will stop when the phone's handset is pick up (Off Hook). The Central Office generates a ringing signal whenever it has an inbound call for the subscriber. The subscriber will hear the ringing and know to pick up the phone to answer an incoming call.

An incoming call is indicated by ringing signal on the recipient's phone send from the Central Office. The central office can detect the picking up of the recipient's phone's handset (Off Hook state), and will stop sending the ringing signal. The Central Office will then connect the incoming call to the recipient's local loop (FIG. 1 and FIG. 4B). When the call is completed and the recipient or caller hangs-up (On Hook state) is detected the phone goes back in to a neutral state.

An outgoing call is detected by the Central Office when the subscriber picks up the handset creating an Off Hook state. When the subscriber picks up the handset, the open circuit connecting the Central Office to the phone is closed (local loop is completed), and current flow through it. The central office detecting the flowing current, will signal the subscriber with a Dial tone, tell the user that the phone line is ready for use. A Dial tone is two monotones of 350 Hz and 440 Hz, these tones form a distinct DTMF (Dual Tone Multi Frequency) tone. The Dial tone (FIG. 2C) lets the subscriber know that their phone is connected to the Central Office and is ready to accept the phone number that they are about to dial. Once the user dials the first digit of the phone number the Central Office will stop the dial tone and connect the dialed phone number.

SkyRider

A SkyRider can be divided into three components, a wireless device (cell phone), a Base Unit, and one or more “EXTENSION” phones (E-Phones, E2Phone, or E3Phone) linked to the Base Unit. Both the wireless device and the “EXTENSION” phones are plugged into the Base Unit. In the preferred embodiment the wireless device is linked to the Base Unit by a Connection Port, generally located at the base of the wireless device. In the preferred embodiment the “EXTENSION” phone line plugs into the Base Unit at a normal telephone socket (RJ-11). A normal telephone may serve as an E-Phone for a SkyRider System, or a specially designed phone (E2Phone/E3Phone) may be employed as an “EXTENSION” for the cell phone in the SkyRider.

Two wired (line) phones can be used to form an intercom, all that is needed is a power source and a resistor. You can create an intercom out of two wired telephone by connecting the red wires to a 9-volt batter in series with a 300 ohm resistor, and the green wires to one another (FIG. 5). The resulting intercom system is the proto-type for “EXTENSION” Phones. When this intercom system is linked to cell phone at you get a primitive E-Phone (intercom system with the ability to generate DTMF-tones, Re-Dial functionality, et cetera), an intercom system over which the user can talk on a cell phone. This Intercom system will be able to generate/transmit DTMF-tone when key(s) on its keypad are pressed.

In one embodiment the Base unit of the SkyRider is composed of a Ring Generator, a microprocessor (Pic), DTMF-tone detector, a Dial-tone generator, optional display panel (Liquid Crystal Display), and an Off Hook state sensor.

FIGS. 6A & 6B illustrates two different embodiments of the Base Unit (120) used in a SkyRider. FIG. 6A illustrates the embodiment of a Base Unit used with an E-Phone. FIG. 6B illustrate the embodiment of a Base Unit used with an E2Phone. The main components of a Base Unit is a sensory array 122 (S1 and S2), relays 130 (R1, R2, & R3), stamp 124 (containing a micro-processing unit, EEPROM, clock and RAM memory), DTMF (Dual Tone Multi-Frequency) decoder and encoder chip 126, voltage regulator and a power supply. The Base Unit is interposed between “EXTENSION” phones and the Cellular Phone (wireless device) as shown in FIG. 2 and FIG. 3A.

In an alternate embodiment, the Base Unit may have more than one Connection Port, and accept more than one cell phone at a time. This will allow for multiple cell phones recharging at the same time, and allow each wireless device a chance to be used with the SkyRider. If one of the cell phones get an incoming call while the SkyRider is currently handling a call on one of the other cell phone, the new cell phone will ring. The phone will continue to ring until it is answered or the new caller ends the call. The owner of the cell phone can remove the cell phone from the SkyRider and answer the incoming call while the other user continues with their call on the “EXTENSION” phone. If the current call end their call, they can answer the new incoming call. In another embodiment, the user can place their current call on hold and answer the new incoming call.

The sensor array (FIG. 6—122) may consist of the following two sensors: ring sensor 122-1, and an answer/off hook sensor 122-2. The off hook/answering sensor 122-2, in one embodiment, comprises an alternating current optoisolator coupler. The coupler is attached to the phone line by a forward facing diode, allowing only positive current to flow through the diode and trigger the coupler. When the “EXTENSION” phone 110 is off the hook, current flows through the phone line to the coupler. The light emitting diode inside the coupler activates a photo-transistor. The photo-transistor allows current to flow through it to a pin on the microprocessor. The microprocessor detects the current as a high signal, indicating the Off Hook status of the E-Phone. The ringing sensor 122-1 comprises an alternating current optoisolator coupler. The coupler may be attached to the “EXTENSION” line by a reverse facing diode, allowing only negative current to flow through the diode and the trigger of the coupler. Ringing is a process that employs both positive and negative moving current. The reverse facing diode allows only the negative current to reach the coupler. The light emitting diode inside the coupler, in one embodiment, activates a photo-transistor. The photo-transistor allows current to flow through it to a pin on the microprocessor. The microprocessor detects the current as a high signal, indicating ringing of the phone.

The optoisolator couplers employed, in one embodiment, is part number H11AA814AQT-ND or H11AA814QT-ND manufactured by Optoelectronics. The optoisolator triac may be part number MOC3010QT-ND also manufactured by Optoelectronics. Of course, other components and/or configurations may be used for accomplishing such monitoring.

The relays 130 used in one embodiment of the Base Unit (120) have both a normal close circuit and a normal open circuit. The application of a current to the coil will cause the normally open circuit to close, and the normally closed circuit to open. The Default State (no power applied to the coil) allows a telephone call to pass through the Base Unit (120). In the default state of the Relays the “EXTENSION” phone lines is connected to a Ring and Dial tone generator. This connection allows the microprocessor to introduce either a Dial tone or a Ringing signal into the “EXTENSION” phones, enabling the Base Unit to emulate a Central Office. When a current is applied to the coils of relay 1 (R1) 130-1 and relay 2 (R2) 130-2, an alternate path is opened, one that routes the connecting “EXTENSION” phone line to the DTMF transceiver (FIGS. 6A & 6B) 126 and voice line. This re-routing of the “EXTENSION” phones line allows the DTMF Transceiver (CM8880) to monitor/read DTMF tones originating from the “EXTENSION” phone 110. The transceiver converts the dialed phone number from encoded as DTMF tones into binary code. The binary code is passed to the microprocessor via a data bus.

In one embodiment, the relays 130 used are part #G6E-134P-ST-US-DC5 made by Omron. Of course, other components and/or configurations may be used for accomplishing such control over the telephone line wiring.

In one embodiment a stamp (124) is employed by Base Unit (120) and comprises a PIC-micro-controller chip (microprocessor), PBasic interpreter chip (software language use to program the micro-controller), EEPROM (electrically erasable programmable read only memory), RAM (Random Access Memory), clock and ports through which information and instructions can be passed. In this embodiment these ports are called pins, and each pin may be in either a high or low state. The micro-controller uses the state of the sensor pins to monitor the phone line for activity. The sensors 122 are attached to specific pins on the micro-controller, and when these pins go high or low, the micro-controller via the program store in its memory, can determine what is happening. The micro-controller is able to detect an active phone state by monitoring the pin connected to the “S1” (off hook sensor). The relays 130-1 and 130-2 used in the Base Unit (120) are attached to specific pins of the micro-controller. The micro-controller knows which pins are attached to which relays 130, and the programming stored in the Stamp tells the micro-controller when each relay should be employed. The micro-controller can activate a specific relay by outputting a small voltage to the pin attached to that relay coil. When the pin goes high the relay 130 is activated, and when the pin goes low the relay 130 is de-activated. In one embodiment a stamp II (124) manufactured by Parallax Inc./Microchip Technology (part #PIC 16C57) is used. Of course, other components and/or configurations may be used for accomplishing such control and monitoring of SkyRider activity.

The CM8880 126 is a fully integrated DTMF transceiver. This transceiver 126 may be interfaced with a computer/ microprocessor to detect and interpret DTMF signals. The transceiver 126 is attached to the “EXTENSION” phones 110 via the alternate path created when the relay 1 (130-1) and relay 2 (130-2) are activated. By placing the transceiver (FIG. 6—126) connection on the alternate path of the phone line, it is protected from the high voltage of “EXTENSION” phones ringing. The phone ring consists of both forward and backward flowing (AC) current at a voltage level that could otherwise damage the transceiver 126.

In an alternate embodiment the “EXTENSION” phones can be digital (E2Phones), and not require a high alternating voltage signal to generate a ringing signal for the phone user. In the preferred embodiment, the “EXTENSION” would be able to take advantage of the cellular phone customize the ringing capabilities. This version of the “EXTENSION” phone is referred to as an E2PHONE (FIGS. 10 & 11). The E2PHONE will also have a display panel similar to that of a cell phone, allowing the user to view text messages and picture sent to them by other cell phones.

Once the microprocessor detects an outgoing call state, it triggers the relays 130 that bring the transceiver (FIG. 6—126) in contact with the phone line. This will enable the transceiver 126 to interpret the DTMF tones on the phone line, and pass it to the microprocessor. Although the current embodiment employs a CM8880 DTMF transceiver made by California Micro Devices (part #CM8880PI), other components and/or configurations may be used for accomplishing such decoding and encoding of DTMF.

A standard 9-volt and a standard 5-volt regulator may be employed as a power source for the Base Unit (120). The 5-volt supply may be used to power the DTMF transceiver 126, the relays 130, the sensors 122 to signal the microprocessor and the stamp (124). The 9-volt source powers the isolated telephone 110. The 5 volt and 9 volt regulators used by the Base Unit 126 may be, in one embodiment, Japan Radio Company part #NJM7809-FA and NJM7805-FA, respectively. Of course, other components may be used for accomplishing such regulation of voltage.

Connection Port

The Connection Port (FIGS. 6A & 6B CP) is a group of pins generally located at the bottom of the cell phone (wireless device). This port consists of a number of pins that are used to communication information and/or instructions between an external device and the cell phone. The external device also has a connection port compose of complementary fitting. The Connection Port can be used to link a wireless device to Personal Data Assistant (PDA), laptop computer, or hands free units that provide external microphones and headset. In the preferred embodiment the SkyRider will use the Connection Port to link the Base Unit Data Bus with the Wireless device Data Bus. The two linked Data Buses will be used to convey conversation, telephone numbers, and instructions in the form of electrical signals, between the wireless device and the “EXTENSION” phone. In another embodiment the signals transmitted between the wireless device and an “EXTENSION” can be in the form of DTMF tones. Many of the wireless phones already have the ability to convey conversation via the Connection Port to hand-free headsets that contain a microphone and a small speaker. The ability to accept dialing instruction and phone number via the Connection Port may or may not be already programmed into the wireless device. However this capability can be readily programmed into the cell phone by anyone skilled in programming and knowledgeable of the coding/command required. Employing existing capabilities with the cell phone, or newly added described capability it is possible to make a SkyRider. In the preferred linkage between the Base Unit and the wireless device, some of the Pins of the connection port can be used to detect and monitor the status of the cellular phone: to know when it is ringing, or know when outgoing calls are possible.

In another embodiment the Pins in the Connection Port may be configured to activate key on the keypad of the cell phone, allowing the Base Unit to transmit instructions/information between the two devices: “EXTENSION” and Cell Phone. The information will take the form of instruction to the cell phone to mimic the pressing certain command keys, or numeric key on the keypad (FIG. 11B). The SkyRider will be able to transmit commands and specific Phone Numbers by manipulating the state of various pins/combination of pins composing the Connection Port of the wireless device. The cell phone will be able to communicate back to the Base Unit by manipulating it pins. Since each cell phone company/manufacture may have it own set of proprietary codes for handling input into and out of the cell phone via the connection port, each SkyRider will have to be designed and manufacture for a specific cell phone company. However, if at some future date, this is standardized it will be possible for a SkyRider to work with any cell phone (wireless telephony device). In another embodiment, several different manufactures command coding, pin configurations/protocols may be include in the Base Unit, and the user make select from a listing which one they want to use. The Base Unit will configure itself to accommodate the selected manufactures cell phone at the Connection Port. Any engineer skilled in the art with access to the proper codes will be able to program the SkyRider to work with a cell phone.

Incoming Call

In the preferred embodiment, when the Cell Phone is ringing the appropriate pin of the cellular phone's Connection Port will signal this event. The Cell Phone Connection Port is interfaced with the Base Unit's Connection Port in a male to female configuration. The data bus linking the Connection Port to the Base Unit's Microprocessor (FIG. 6) will detect the state of the cell phone and trigger relays R1, R2, and R3 to a ringing position. In one embodiment, the ringing position of the Base Unit Relays routes the red wire to the Ringer & Dial Tone Generator away from the CM8880 (FIG. 6—140). Relay R3 will be configured to provide a ground for the ringing signal, and protect the voice path from the high voltage of the ringing signal. The Microprocessor will signal the Ringer to generate a ringing signal on the “EXTENSION” phone line. The “EXTENSION” phone will start ringing when it experiences the (in one embodiment, alternation current) signal. When subscriber lifts the handset (Off Hook state) the circuitry in the phone that response to the ringing will disengage and a close loop will exit. In one embodiment, this closed loop will cause the off hoop sensory to go positive and the ringing sensor to go negative, creating a distinct sequence of events that the microprocessor will interpret as answering a phone call.

When the subscriber lifts the handset from it cradle an off hook state is created. The microprocessor monitoring the sensors will detect the off hook state, will respond by stopping the Ringing, re-route the red wire to the DTMF tone detector, establishing a close circuit for the voice path (FIG. 6).

The Base Unit will enter a neutral state once it has detected the lifting of the handset to accept the incoming call and it opens the voice path to the “EXTENSION” phone. In the neutral state the Base Unit will continue until the call has ended. After the incoming call has ended the Base Unit will return to it wait state, looking for new outgoing call or a new incoming call. In one embodiment, the voice path to the “EXTENSION” phone is the same path that a hand-free set would use. Almost all cell phones are designed to accept a hand-free setup involving a speaker and microphone attachment.

Outgoing Calls

An outgoing call is detected when the subscriber/user lifts the handset out of the cradle and there is no incoming call. In one embodiment, the Base Unit, monitoring the Sensory for the “EXTENSION” phones will detect this as an outgoing call state, and will immediate check with the cell phone status to determine if the cell phone free to make an outgoing call. The Base Unit will then send signal to the Ringer & Dial Tone Generator instructing it to produce a Dial Tone. The duration of the dial tone can vary, from three seconds at the lifting of the receiver, to until the user enters the first digit. If the cell phone is not available due to a current outgoing call, the “EXTENSION” phone will behave like a regular line phone in use. The user will be able to hear the current on going call.

In an alternate embodiment, the Base Unit can accept the user entered phone number even if there is no service at that exact moment (Cell Phone is unable to immediately establish connection with the wireless communication network). The Base Unit will pause briefly once the user has entered phone number while service is being established (access to the wireless communication network).

In one embodiment, the Base Unit will signal to the Cell Phone via the Connection Port to prepare for an outgoing call. This will involve the Cell Phone microprocessor clearing the dial buffer, Check to make sure service is available to the cell phone (access to the communication network), and any other step that are require to prep the cell phone for an outgoing call. The Base Unit preparation for an outgoing call can vary with each model of cell phone. In one embodiment, the Relays will re-configure the wiring to establish a connection with the CM8880 detector and voice path. The Base Unit will monitor the re-configure circuit for the DTMF-tones of the phone number being dialed by the user. The DTMF-Tones are captured by the CM8880 and converted into binary and passed to the Base Unit's microprocessor via the connecting data bus. The Base Unit will interact with the cell phone microprocessor, setting up the cell phone to accept the dialed phone number. The Base Unit's microprocessor will communicate the captured phone number to the cell phone via the Connection Port. The dialed phone number will be properly formatted by the Base Unit before it is passed through the connection port to the cell phone. In one embodiment, the Passed phone number will appear as if it is a phone number entered from the cell phone's memory. In another embodiment the passed phone number will appear as if it is a phone number entered via the cell phone's keypad.

The Microprocessor will continue to monitor the “EXTENSION” phone circuit for a send signal. In one embodiment, a “#” (number symbol) from the “EXTENSION” phone (E-Phone) will trigger the dialing of the transmitted phone number. In another embodiment, the pressing of a “Send Key”, on the “EXTENSION” phone Keypad will trigger the dialing process (E2Phone/E3Phone). Cell phones require the user to press a specific button to initiate the dialing process. In another alternate embodiment, a designated Key/combination of keys on the keypad will trigger the dialing process.

In an another alternate embodiment, the Base Unit could trigger the dialing process whenever it captures twelve (12) digits without a leading “1”, or when it captures thirteen (13) digits with a one (1) in the leading position. In an alternate embodiment the dialing process could be initiated when a certain amount of time has elapse. In the preferred embodiment, there would be allowance for special phone numbers such as “911”, “0”, “411”, et cetera. That certain predetermine digits will trigger the dialing process when a specific number of digits are collected within a set time period. This preferred embodiment for dealing with international calls from an “EXTENSION” phone for dealing with for international calls that begin with as “0” (i.e. 011-XYZ). In the preferred embodiment, the Base Unit will enter a neutral state once it has dialed the capture phone number, it will monitor the “On-Hook” sensor to determine when the call has ended. The Base Unit will stay in an inactive state until the call has ended, then it will return to it wait state, looking for a new outgoing call or a new incoming call.

In alternate embodiment, components normally contained with a cell phone can be used to create a Base Unit. Cell phones have many if not all of the components needed to create a Base Unit already inside of them. All that is needed is external access to these components. By adding an external keypad and a speaker and microphone, to create a SkyRider. FIG. 11B illustrates one embodiment of this approach to creating a SkyRider. The external Keypad and the microphone and speaker (derived from the hand-free speaker and microphone circuit) are linked to the cell phone (wireless device) via the cell phone Connection Port's pins. The Connection Port pins will link external keypad to the same circuits that normally monitor input from the cell phone's normal keypad. When input from either of the two keypads is indistinguishable from one another, and an external speaker and microphone is employed, you will have a SkyRider. Hands-free headsets circuits are readily available on cell phone to provide both speaker and microphone, all that is needed is an external keypad and programming of the connection port to accept input from an external source as input from the keypad.

In alternate embodiment it is possible to incorporate a SkyRider Base Unit into a regular line telephone (FIG. 12). This type of phone will be referred to as an E3Phone “EXTENSION”. An E3Phone would enable the user to handle both line calls and cell phone calls from the same telephone. This would be advantageous to users that want to use their wireless phone both in their office, a client's office, moving about, or at home. In one embodiment, the E3Phone (“EXTENSION”) will allow the user to place either a line phone caller, or the cell phone caller on hold, by pressing a button. This feature will allow the user to effective switch between the two callers. In an another embodiment the user can join the caller from both communication network, to form a group conversation.

FIG. 1 illustrates one embodiment of the SkyRider invention, in which a cellular phone and a line phone (wire and wireless telephonic devices) are linked to a communication network (100). The communication network provides service to both wired telephones denoted as 112, and the wireless phone denoted as 190. The Base Unit of the SkyRider is denoted as 120, an operator is denoted as 180 and the “EXTENSION” phone/E2Phone are denoted as 110.

FIG. 2 illustrates one embodiment of the SkyRider invention employed in a house/apartment. In this illustration, the SkyRider has two “EXTENSION” phones linked to it via common telephone line wire. The wireless phone is plugged into Base Unit and the “EXTENSION” phones are located about the house/apartment. This will allow the user of the SkyRider to access incoming call and make outgoing calls from any location within the house/apartment the say way they would with a regular line phone extension (only they are using a cell phone and accessing with an “EXTENSION” phone

FIG. 3, illustrates one embodiment of the SkyRider's invention (without an “EXTENSION” phone), showing a wireless device that used links it to a communication network and a Base Unit that is used to connect the “EXTENSION” phones (E-Phone, E2Phone, or E3Phone). In this embodiment, the Base Unit has two RJ11 sockets for linking to the “EXTENSION” phone. However, in another embodiment other types of sockets and wiring may be employed to connect to the “EXTENSION” phones to the Base Unit: the Base Unit may employ USB Ports and cable, Fiber Optics ports and cables, Coaxial ports and Cable for connection. In one embodiment the Connection Port on the Base Unit is male and will interface with a female counter part on the wireless device. In an alternate embodiment, the wireless device can be male and the Base Unit can be female. In an another embodiment, an optical connection port may be used to link the Base Unit to the wireless device (information communicated between the two by infrared light signals).

FIG. 4, illustrate the type of signal that a line phone (wired phone) normally encounters in the performance of its daily operations: signaling an incoming call (Ringing—4A), signaling the answering of an incoming call (Answer—4B), and signaling to indicate dialing of an outgoing phone number (Dialing—4C). It should be noted that a “Time-Out” will occur if the complete phone number is not entered within a define time limited, causing the dialing session to end. When one telephone user calls another telephone user, the communication network signals the receiving party (user that is getting the call) to pick up their telephone handset to accept an incoming call. The common practice is for the central office to send an alternating current signal on the local loop attached to the receiving telephone. FIG. 4A is one embodiment of such a signal send to the receiving phone; the electrical signal will cause ringing to occur. When the ringing telephone is handset is picked-up (answering the call), a switch at the central office is closed. The closing of the switch at the central office terminates the ringing signal, and connects the incoming call to the receiving telephone. FIG. 4B, illustrates one embodiment of the signal that is generated when a ringing telephone is answered by the receiving telephone user. FIG. 4C, illustrate one embodiment of what happens when a telephone user picks up a handset to make an outgoing call. It is important for the SkyRider to mimic these signals, they will allow for the user to be able to attached other device to it and have them function properly. One such attachment may be a fax machine. Such an attachment will expect to encounter signaling common to a normal phone line. The employment of regular telephones as “EXTENSION” phone may also necessitate the need for the above described signaling for proper function.

FIG. 5A & FIG. 5B, illustrate the basic concept of an “EXTENSION” phone evolving from a regular phone. A basic line phone can be converted into an intercom, by the simple addition of a 9-volt battery and a 300-ohm resistor. The telephone will provide the electronics needed to speak and be heard over the intercom system. By linking a cell phone to the intercom via a hand-free speaker and microphone connection (socket), it is possible to conduct a conversation via the intercom with a cell phone caller. FIG. 5B, illustrates one embodiment of line telephones forming an intercom system linked to a cell phone.

FIG. 6, illustrate one embodiment of a Base Unit linked to two “EXTENSION” phones. In this embodiment, the two “EXTENSION” phones are linked to the Base Unit by RJ11 sockets. Telephones line running from the “EXTENSION” phones to the Base Unit plug into RJ11 sockets. The Cell Phone plugs into the Base Unit at the Connection Port (C.P.). The microprocessor is the heart of the Base Unit, it monitors and controls all of activity of the SkyRider. The microprocessor monitor and control the CM8880 (DTMF transceiver) to detected “EXTENSION” phone dialed telephone numbers encode in DTMF-tones. The CM8880 can also introduce DTMF-tones (Dial tone) into the “EXTENSION” phone. The microprocessor controls an arrangement of relays to route signals and conversation within the Base Unit. The microprocessor configures the relays to route ringing signals to the “EXTENSION” phone when the cell phone detects an incoming call. The ringing signal (FIG. 4A) is generated by a Ring Generator when the Base Unit's microprocessor detects an incoming cell phone call. The microprocessor can detected incoming call by monitoring the activity status of the cell phone via the Connection Port. The sensor array (122) is used by the microprocessor to determine the status of the “EXTENSION” phone. In one embodiment the microprocessor will use the sensor array to determine the status of the “EXTENSION” phones. The Base Unit will determined an outgoing call is being make when the handset is picked up (Off Hook) while no income call is occurring (FIG. 4C). The microprocessor working with memory and program coding will choreograph the various components of the Base Unit to allow incoming an outgoing call to occur over the “EXTENSION” phones. A phone number dialed on an “EXTENSION” phone will be communicated to the Cell phone via a common data bus linking the Base Unit and the cell phone via a Connection Port. FIG. 6A is a block diagram of one embodiment of an E-Phone Base Unit (with two attached “EXTENSION”). FIG. 6B is a block diagram of one embodiment of an E2Phone Base Unit (with two attached “EXTENSION”). In the preferred embodiment of the E2Phone there is a video driver, that will allow for a display screen be attached to the “EXTENSION”. Note this would be in addition to a small Liquid Crystal Display screen that come on many new line phones. The Display screen would allow the SkyRider to distribute the cell phone video capabilities to the “EXTENSION” phones. In another embodiment, the E3Phones (“EXTENSION”) will also have distributed video capability from their attached cell phone.

FIG. 7, illustrates one embodiment of how a cell phone might interact with the Base Unit via the Connection Port. The Connection Port is a point at which the data bus of the Base Unit and The Cell Phone connect, and exchange information. An incoming call from the communication network will trigger pre-programmed events within the cell phone, decoding the incoming information packets that contain the set-up information for the call (telephone number of caller, what tower the call is coming from, what frequency it is being transmitted on, et cetera). In one embodiment, the microprocessor in the Base Unit will recognized this type of information being process within the cell phone (i.e. program coding that instructs the cell phone to start ringing). The Base Unit's microprocessor is able to detect the cell phone ring signal, because both the cell phone and the Base Unit can communicate with one another over their linking Connection Ports. The Base Unit will activate the Ringer & Dial-tone Generator, causing the “EXTENSION” phones to ring. When the Base Unit microprocessor detects someone picking up the “EXTENSION” phone handset, it will stop the ringing and signal the cell phone. The signal to the cell phone will be the same as when the user normally answers an incoming call, causing voice communication to be established between the caller and the cell phone. In one embodiment the voice communication is routed to the “EXTENSION” phone the same way that a hand-free headset would route to the speaker and microphone. When the user places the handset back into the cradle (terminating the call), the Base unit will present a signal to the cell phone microprocessor that is the same as a normal end call signal. An outgoing call from the cell phone could be performed with the following process. In one embodiment, when the cell phone user presses a key on the cell phone keypad, a chip (MC14512) translates pressed keys into electrical signals that are conveyed to the wireless device microprocessor. In an alternate embodiment, making this chip accessible to an external keypad can be used in the creation of a SkyRider, when employed with the hand-free headset circuit (FIG. 10). The input from the external Keypad of an “EXTENSION” phone will be load into the wireless device as if it were being entered on the device actual keypad. The cell phone's microprocessor will load the phone number into both the Dialing Buffer and Display Panel. The loaded telephone number and other information is process by the various component of the cell phone (digitizes and compressed into a data packet(s) readied for transmission). When the cell phone user pressed the dial/send key (the button that transmits/initiates the calling process), the data packet is transmitted over the communication network via the nearest cell phone tower. When an “EXTENSION” phone user makes an outgoing call the phone number entered on it keypad is transmitted as electrical signals to the Base Unit. The CM8880 will capture and stored each digit of the dialed phone number in the Base Unit as electronic signals. As each number is entered, the Base Unit will check to see it the cumulative number and order of the digits collected constitutes a valid phone number (i.e. 212, 01100, 91119999999 are invalid and 12125551234, 0, 911, and 2125551234 are valid). In one embodiment the Base Unit needs to evaluate the capture phone number to see if it is complete/valid, because the “EXTENSION” phone will not have a Dial/Send key like there is on a cell phone. In another embodiment, the E2Phone “EXTENSION” may have a send button just like a cell phone, in that case there will be less/no need to determine the validity of the entered phone number. In one embodiment, when the “EXTENSION” phone Base Unit's microprocessor detects a valid phone number, it will transmit is along with a Dial/Send Key signal to the cell phone microprocessor. The Dial command will tell the cell phone to execute the call: send the entered phone number out to the communication network. Once the call is placed the cell phone will serve as a conduit for the “EXTENSION” phone, passing through the conversation as it occurs, and the call end signal.

FIG. 8, is one embodiment of the events that occur as an “EXTENSION” phone interacts with it Base Unit.

FIG. 9, is one embodiment of a flow chart showing the various step involved in the operation of a SkyRider. The first step in the SkyRider programming consists of initializing variables and flags (step 900-step 902). The next step in the operational coding of the SkyRider is to check the status of the cell phone (“EXTENSION” phone) to determine if there is an incoming call (step 904). When the Base Unit detection of an incoming call it will trigger ringing in the “EXTENSION” phone (step 924). If there is not ringing (incoming call) the SkyRider will next check to determine if an outgoing call is being attempted, by checking to see if the handset is out of the cradle (Off Hook step 906). If the “EXTENSION” phone handset is not Off Hook, the program will cycle through waiting for activity: incoming or outgoing calls (step 904 to step 906). Once an Off Hook State is detected by the sensor array (FIG. 6, 122), the Base Unit will generate a dial tone, and configure the relay to bring the CM8880 into contact with the “EXTENSION” phone wiring (steps 908 & step 910). This will allow the Base Unit to detect and capture the digits of the outgoing phone number (step 912 to step 916). The Base Unit will constantly check the collected digits to determine if the user has entered a valid phone number (step 918). This step may not be required E2Phones if the “EXTENSION” phone has a Dial, or Send key build into the keypad (FIG. 10). Both the number of digits and the sequence of the digits will be used to help determine the validity of an entered phone number, and dialing will be executed (FIG. 9, step 920). In an alternate embodiment, an “EXTENSION” phone will be equipped with a Send Key, or the functional equivalent of the key that is used in cell phones to execute the dialing process once the phone number is entered. After the “EXTENSION” phone user has finished entering a telephone number, the user will press the Send Key to complete the dialing process. Once the call is initiated, the SkyRider (Base Unit) will monitor for the end of the call (FIG. 9, step 922). The end of the call will be detected as an On Hook state, when the handset has been returned to the cradle, or the End key pressed (FIG. 10). The SkyRider will re-initialize all flags and variables after the call has ended, and await the next event (FIG. 9, step 902). When an incoming call is detected (ringing—step 924), the “EXTENSION” phone will check the status of the handset to determine when the call is answered (FIG. 9, step 924-step 926). The “EXTENSION” phone will continue to ring until it is answered or the caller terminates the call (FIG. 9, step 902, 924, 926). If the phone is answered an Off Hook state is created, and the “EXTENSION” phone will terminate the ringing, and activate the speaker and microphone circuits (FIG. 9, step 928 and step 930). The SkyRider will monitor for the end of the incoming call (FIG. 9, step 932). Once the call has ended, the SkyRider will re-initialize all flags and variables (FIG. 9, step 902).

FIG. 10 illustrates one embodiment of an (E2Phone) “EXTENSION” phone. The E2Phone has several features not common to a regular line phone, giving it greater functionality. The E2Phone has several additional buttons on its keypad than a wired phone: “Send Key”, “Clear Key”, and “End Key” (some line phone have a “Flash Key”). When a user pressed a key on the E2Pone keypad, the Keypad Control Chip transmits a key specific signal to the microprocessor. The cell phone's microprocessor will process the entered signal(s) to determine what button(s) are being pressed and what they mean (is a phone number being entered or a function being called). As the user dial the phone number, the microprocessor will display (Liquid Crystal Display screen, or Video display screen) the detected digits of the phone number, and alert the Base Unit to the pending outgoing call. In one embodiment, the “EXTENSION” E2Phone will communicate with the Base Unit via the RJ11 phone line. In another embodiment the line linking the E2Phone to the Base Unit can be USB cable, Coaxial, fiber optics, or any other medium that can be used to link the two components together. The microprocessor monitors the line connecting the Speaker and Microphone to the Base Unit. The microprocessor in the Base Unit can output signals to the speaker in the “EXTENSION” phone. The E2Phone generates a ringing signal when it encounters an incoming call indicator from the Base Unit. The microprocessor using its connection to the microphone can output a wide variety of signals; this will enable the E2Phone can generate a variety of ringing signals.

FIG. 11A illustrate one embodiment, that will allow the SkyRider to be employed in an office without having to assign workers to specific locations (extensions), to which their incoming calls will be routed by a Local Telephone Network. The Cell phone plugs into the “EXTENSION” phone, negating the need for a Local Telephone Network, having to collect your cell phone from a central location that may be out of the way, and the possibility of having your cell phone lost, stolen, or given to the wrong person. This feature will also allow the user to use their cell phone as regular line phone in any office they happened to be located in, and get it charged at the same time.

FIG. 11B illustrate one embodiment of an E2Phone that utilizes the components of the cell phone to make possible the operations of a SkyRider. In this embodiment, the cell phone and E2Phone passed instructions and communication directly between each other, without processing at Base Unit. Some cell phone manufactures provide software development kits (SDK) to third party companies, to develop new applications and external devices. The software can be used to configure the cell phone to pass and accept instructions and communications.

FIG. 12 illustrates one embodiment of an E3Phone (“EXTENSION” phone). An E3Phone is a regular line phone that can interact with a cell phone. An E3Phone is a phone that has a docketing port for a cell phone. When a cell phone is docked with an E3Phone, it will be able to pass incoming wireless call into the line phone via the Connection Port (docking port). Once docked, the E3Phone will allow the user to accept incoming call over the cell phone or the regular line phone. A series of relay will route the current desired call to the handset (speaker & microphone). In one embodiment, the relays can be control to allow the user specify which communication network they want to use for incoming calls or outgoing calls. In an another embodiment the calls between the two phones can combine, for group conversations. The controlling mechanism can be a button in the “EXTENSION” phone's Keypad. In the preferred embodiment if a call comes in while the speaker is talking to someone they will be able to put the call on hold, in and answer the new incoming call by pressing a key on the keypad (flash key, or some other key or combination of keys). In one embodiment, the outgoing calls will go through the line phone, but the cell phone can be make to accept outgoing call from the cell by pressing a button that makes the line phone keypad input go to the cell phone. The E3Phone would be similar to a two line phone, only one of the lines is wireless. The user will be able switch between the two lines or possibly hold a three-way conversation by linking the wireless and wire calls together. This approach will allow the SkyRider to be employed in an office without having to assign workers to specific locations (extensions), to which their incoming calls will be routed by a Local Telephone Network. The Cell phone plugging directly into the “EXTENSION” phone will negating the need for a “Local Telephone Network”, having to collect the cell phone and route communication from a centralized location (that may be out of the way, and the possibility of having your cell phone lost, stolen, or given to the wrong person).

It will be apparent to those skilled in the art that various modifications and variations can be made in the system and processes of the present invention without departing from the spirit or scope of the invention. Thus, it is intended that the present invention covers the modifications and variations of this invention provided they come within the scope of the appended claims and their equivalents. In this context, equivalents mean each and every implementation for carrying out the functions recited in the claims, even if not explicitly described herein.

### BRIEF DESCRIPTION OF THE DRAWINGS

The present intention will become more fully understood from the detailed description given herein-below and the accompanying drawings which are given by way of illustration only, and therefore are not defining limitation of the present invention.

FIG. 1. Illustrates a system according to one embodiment of the current invention: a communication network with wired and wireless phone connected to it.

FIG. 2. Illustrates a system according to one embodiment of the current invention: an apartment with several E-Phone extensions attached to a SkyRider by a telephone cord.

FIG. 3. Illustrates how the cell phone attaches to the SkyRider (Base Unit) via the Connection Port.

FIG. 4 illustrates electronic signaling used in regular line phones to communicate status/activity. These signals can be mimic by the SkyRider—E-Phone.

FIG. 5A illustrates the evolution of a regular line phone into an E-Phone, by showing how an E-Phone is really a super enhanced intercom system, or a regular phone attached to the SkyRider.

FIG. 6 illustrates one embodiment of a block diagram of the SkyRider, showing modules and attached E-Phones. The base unit supplies the access point, power, circuitry and software needed to make the E-Phone work.

FIG. 7. Illustrates one embodiment of a block diagram of the base components of a cellular phone and how they might work in conjunction with a SkyRider/E-Phone.

FIG. 8 Illustrate one embodiment of a block diagram showing the steps involved in the operation of the SkyRider.

FIG. 9 Illustrates one embodiment of a flow chart showing step in the process of making an outgoing call, or in answering an incoming call.

FIG. 10 Illustrate one embodiment of the components of a phone attached to a SkyRider Base Unit (E-Phone/E2Phone).

FIG. 11 Illustrate one embodiment of an E2Phone that utilizes components within the cell phone to operate.

FIG. 11A Illustrate one embodiment of an E2Phone pins connection to a cell phone.

FIG. 12 Illustrate one embodiment of a regular line phone with a Base Unit incorporated into it.

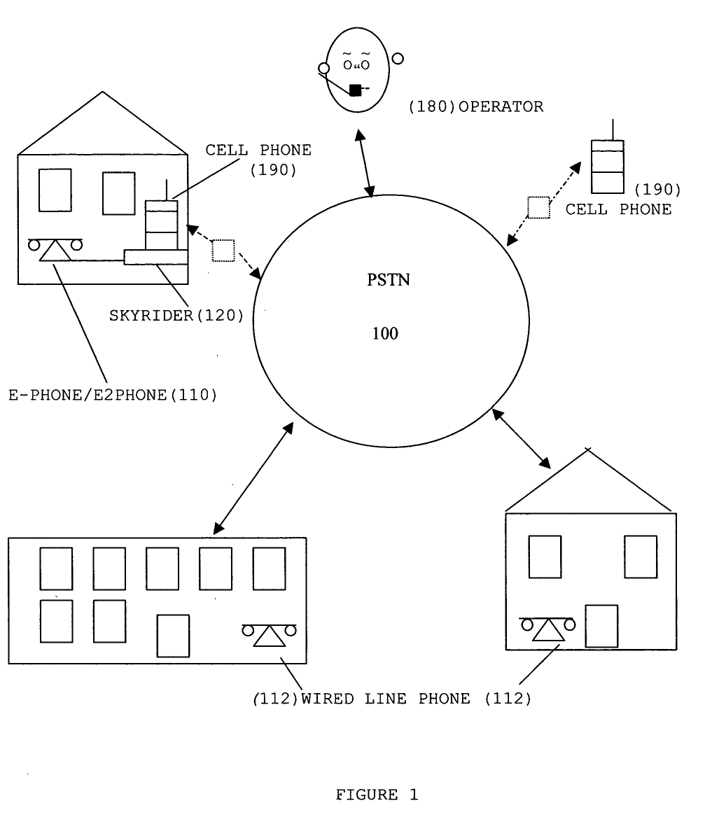

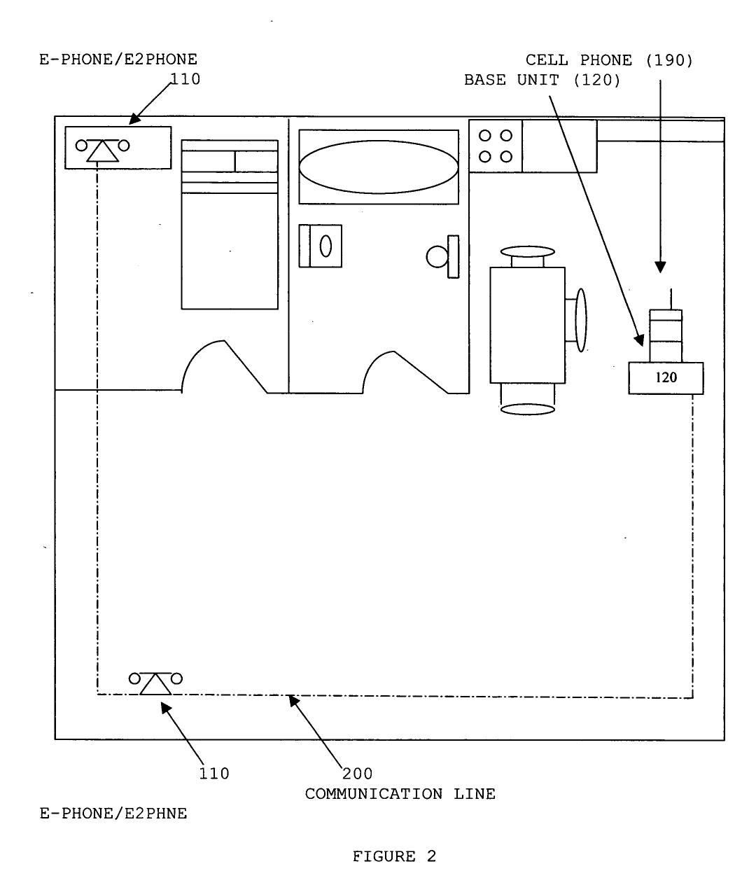

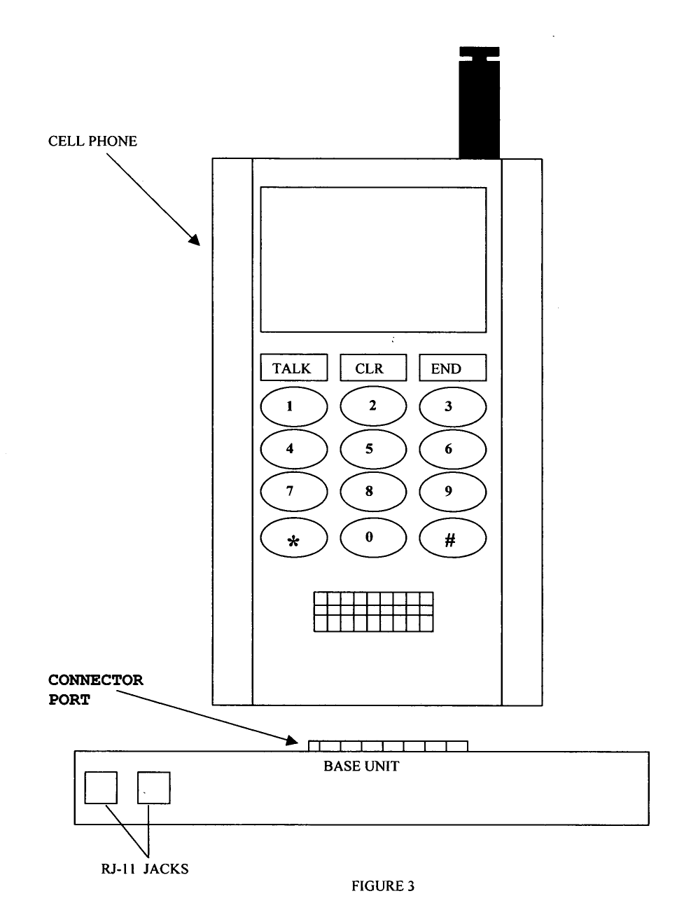

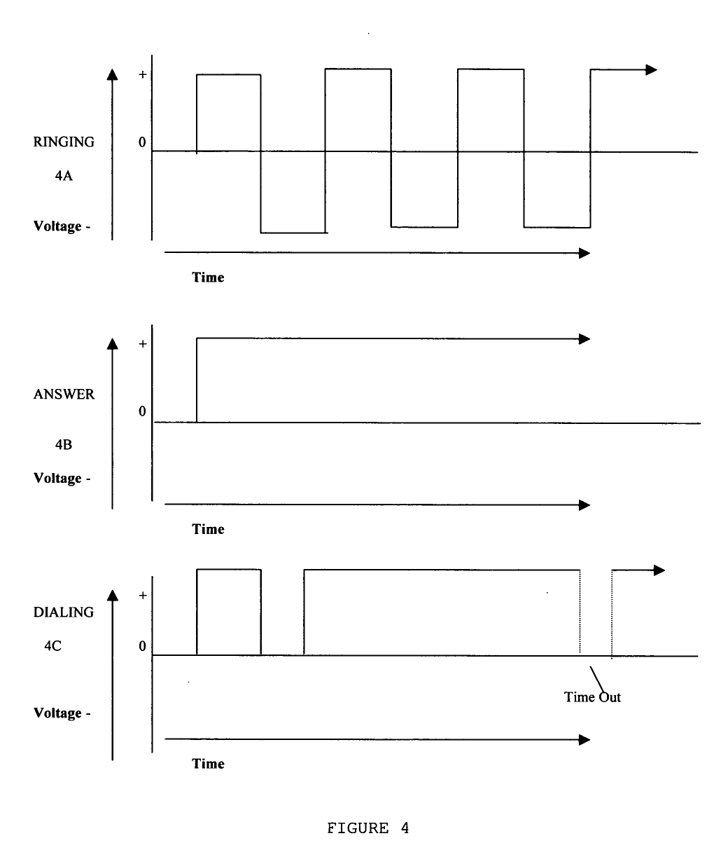

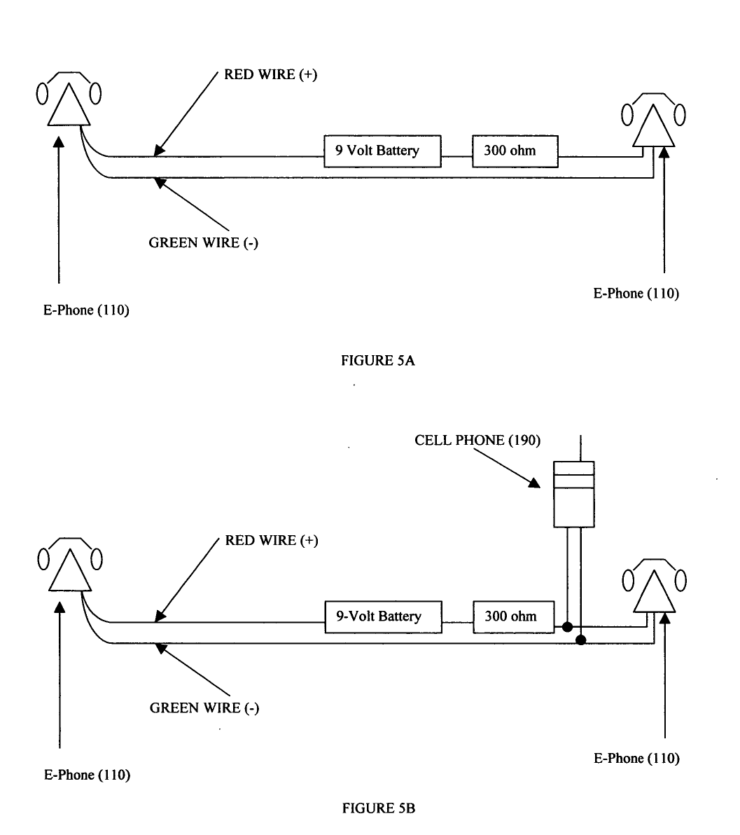

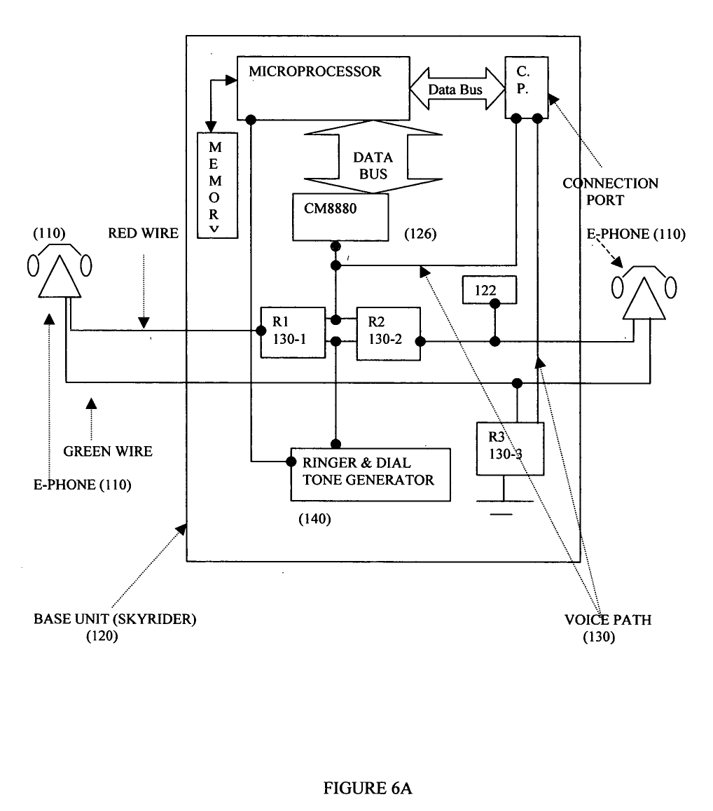

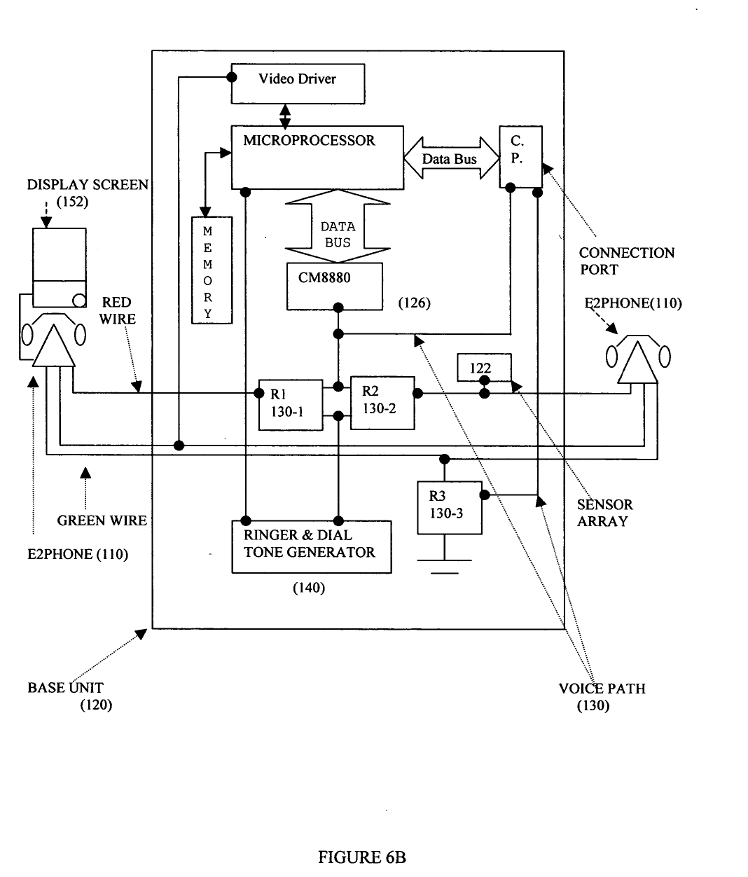

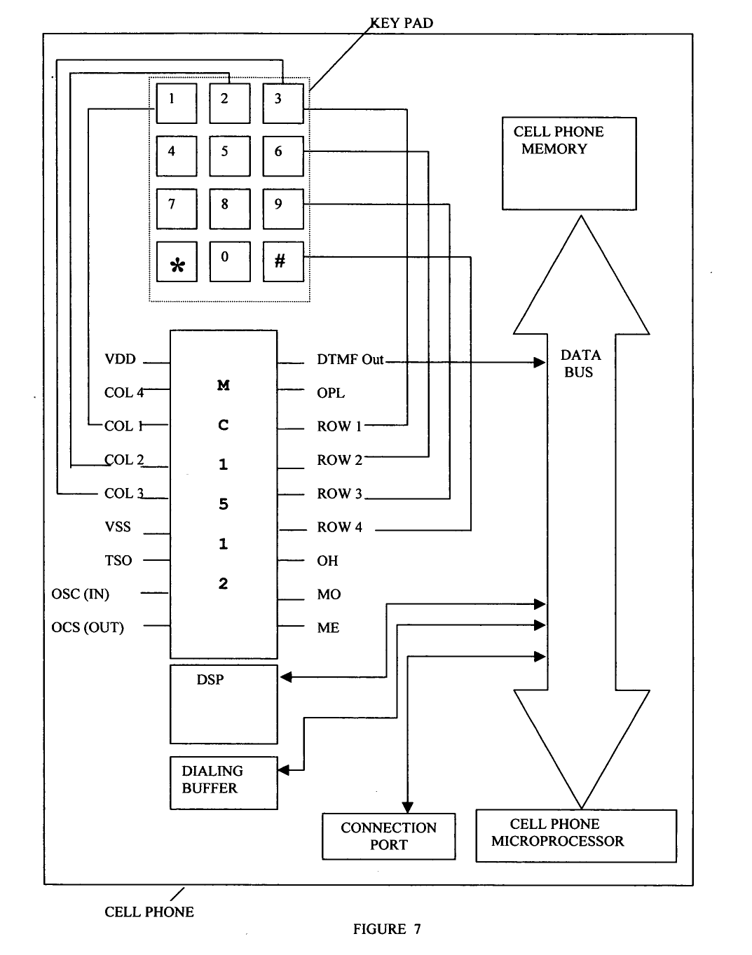

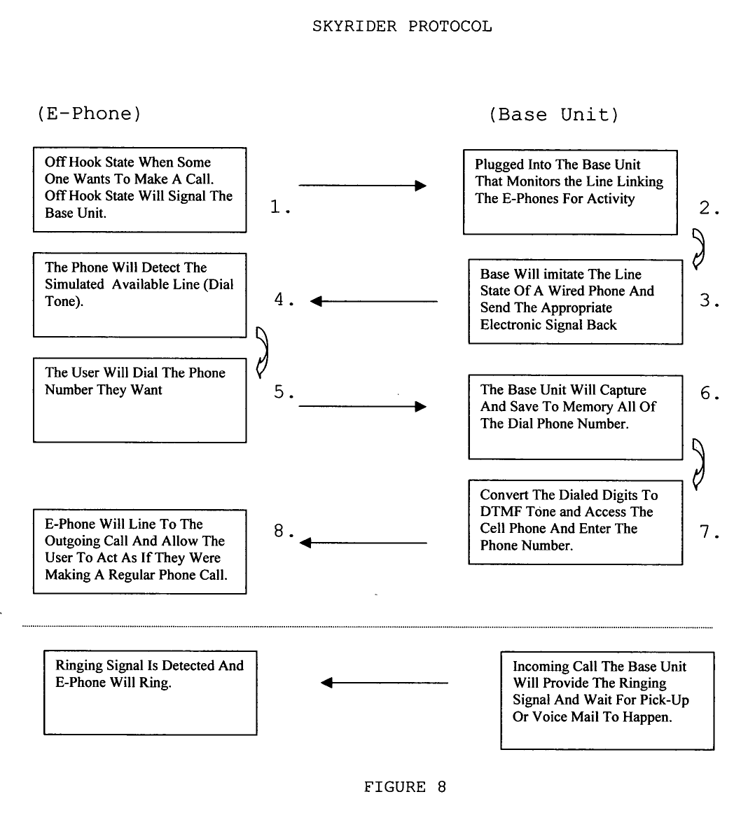

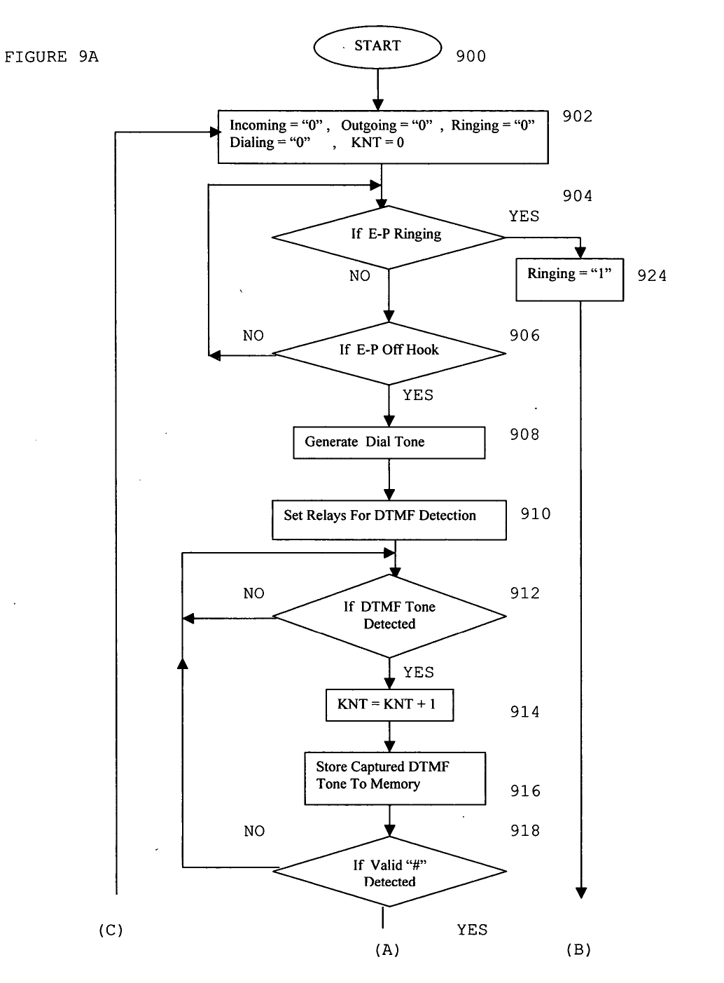

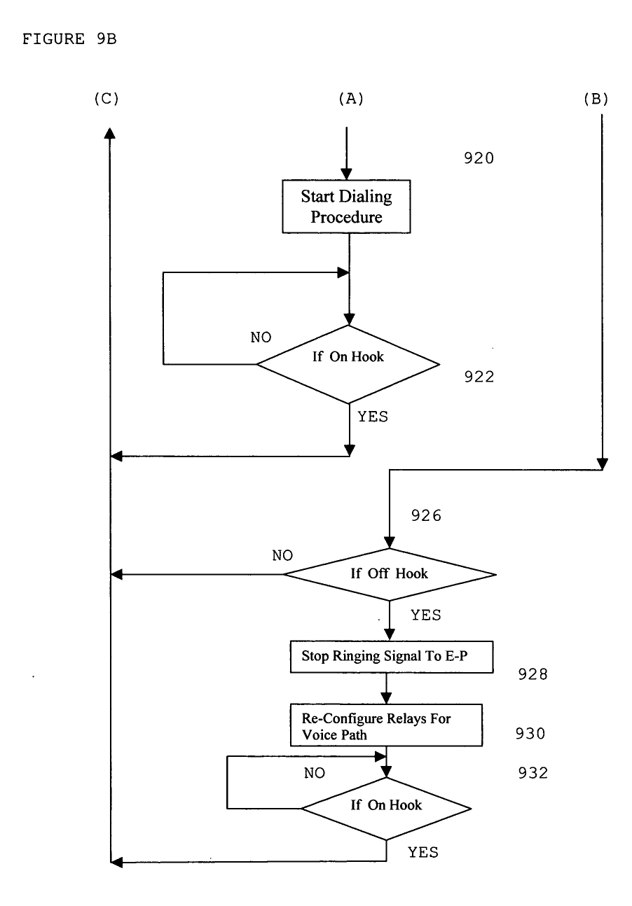

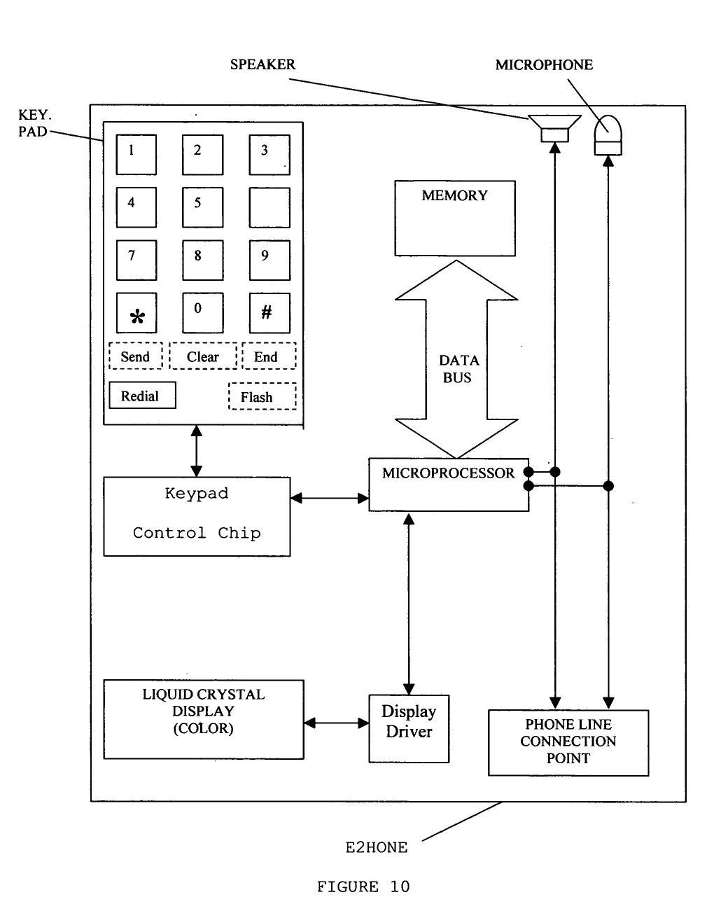

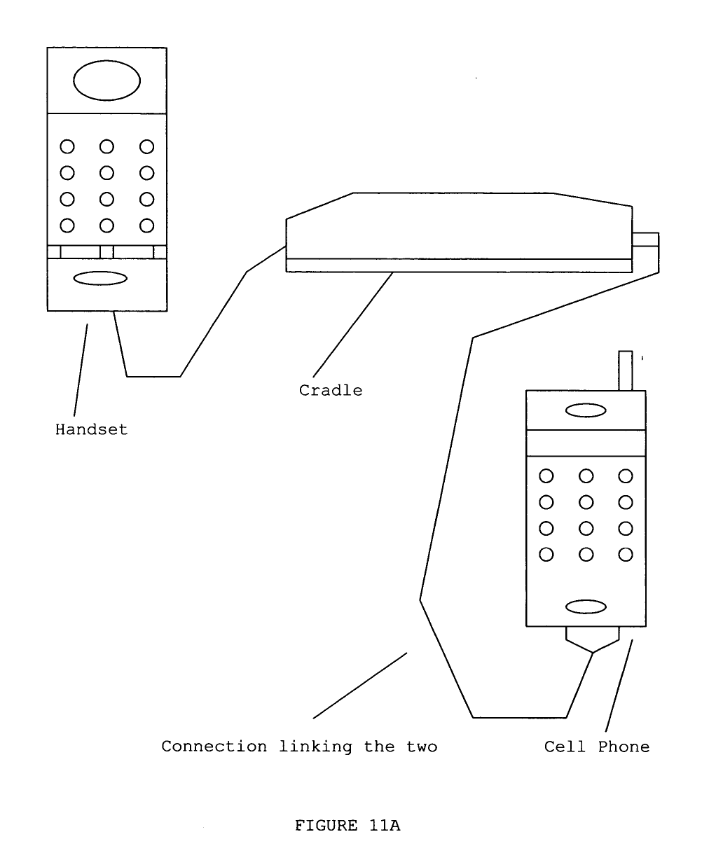

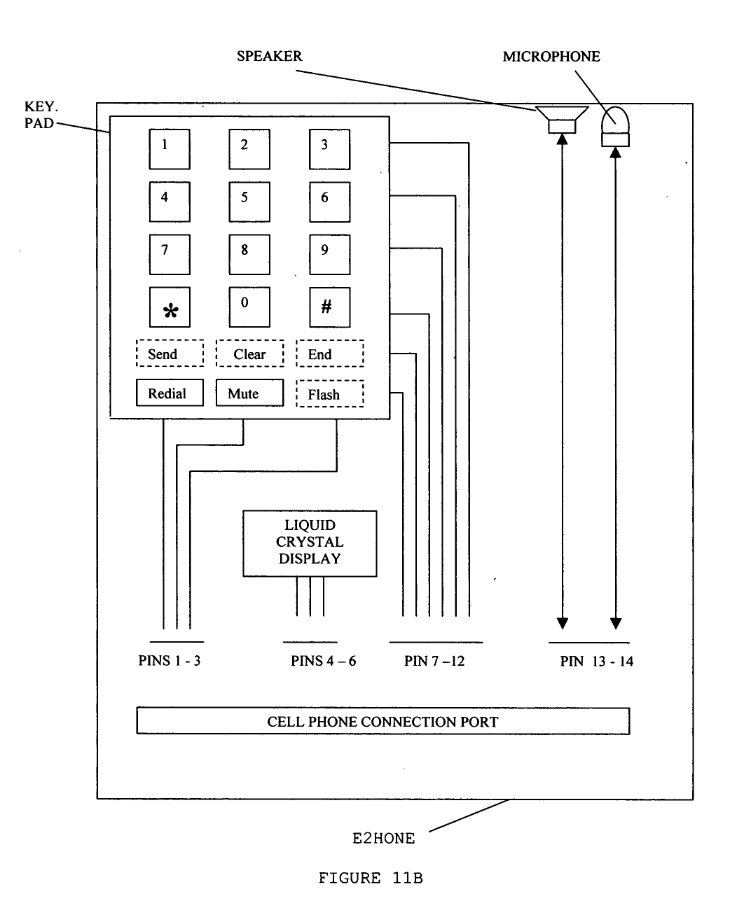

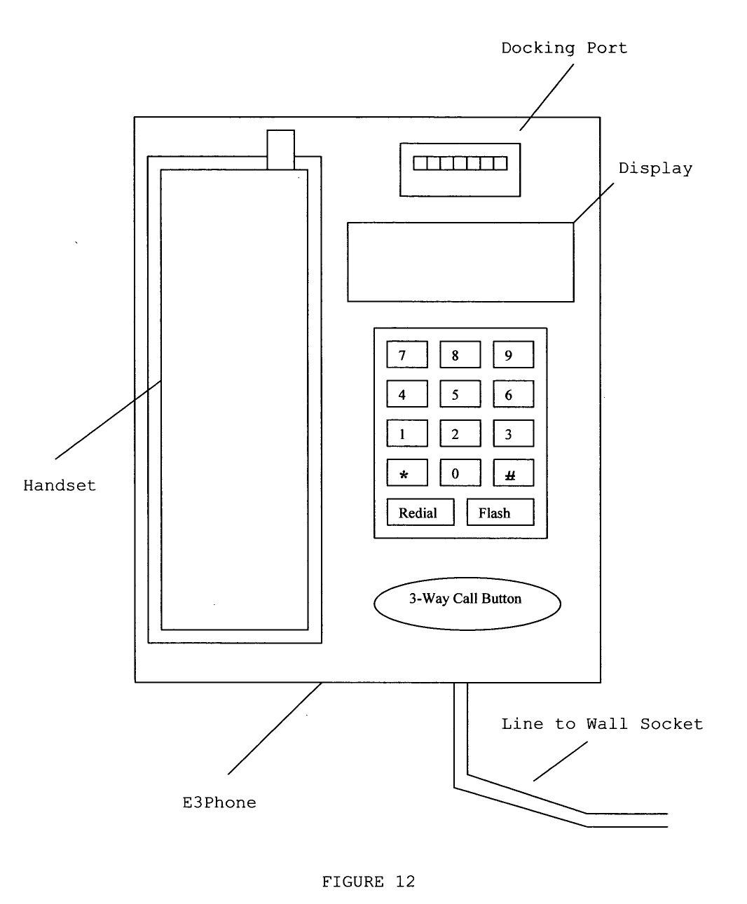

1. A method of adding an extension phones to a wireless telephonic device, comprising:
(a) a mean of interfacing the a wireless telephonic device with one or more extension phone(s);
(b) a mean of allowing the wireless device to be aware of what is happening with the extension phones;
(c) a mean of allowing any extension phone to be aware of what is happening with the wireless device;
(d) a mean of allowing any attached extension phone to initiate activity within the wireless device;
(e) a mean of allowing any attached wireless device to initiate activity within the extension phone.

2. The method of claim 1c, wherein extension phones will be able to signal incoming calls on the wireless telephonic device by.

3. The method of claim 1b, wherein wireless device is able to detect when the extension phones goes off hook in response to signaling of a incoming call.

4. The method of claim 2, wherein wireless device is able to detect when the extension phones goes off hook in response to signaling of a incoming call.

5. The method of claim 2, wherein wireless device is able to detect when the extension phones goes on hook to terminate a call.

6. The method of claim 1b, wherein wireless device is able to detect when the extension phones goes on hook in response to the ending of a call.

7. The method of claim 1d, wherein the extension phones will be able to transmit a telephone number dialed on the extension phone to the wireless device as a dial-able phone number.

8. The method of claim 7, wherein the extension phones will be able to instruct the wireless device to dial the phone number transmit from the extension phone.

9. The method of claim 1d, wherein the extension phones will be able to make outgoing call through the wireless telephonic device.

10. The method of claim 1, wherein monitoring can detect when an incoming call is being answered at the extension phone.

11. A method for merging incoming and outgoing call from both wireless and wired communication into a single device, comprising:
(a) a mean by which a wireless device can communicate through a line phone;
(b) a mean by which a wireless device can be used to make outgoing calls through a wired telephone network;
(c) a mean by which a wired phone can be used to answer call to a wireless device;
(d) a mean by which a wired phone can be used to combine calls on a wired and wireless

12. The method of claim 11, wherein the line phone can monitor for and detect incoming calls on the wireless device.

13. The method of claim 11, wherein the line phone can dial a phone number on the wireless device.

14. The method of claim 13, wherein a call made from the line phone is conducted over the wireless communication network via the wireless device.
(b) codes for charging one or more wireless devices while being used as part of a communication system.

15. A system of adding an extension phones to a wireless telephonic device, comprising:
(a) codes for interfacing the a wireless telephonic device with one or more extension phone(s);
(b) codes for allowing each device to be aware of what is happening in the other device;
(c) codes for allowing each device to initiate activity within the other device;
(a) codes for coordinating the activity with the wireless device and the extension phone.
(b) mean for allowing each device to be aware of what is happening in the other device;
(c) mean for allowing each device to initiate activity within the other device;
(b) mean for coordinating the activity with the wireless device and the extension phone.
